(19) United States
(12) Patent Application Publication
(10) Pub. No.: US 2016/0248527 A1
(43) Pub. Date: Aug. 25, 2016

(54) DISTRIBUTED MULTIMEDIA RECONGIZATION SYSTEM, METHOD, AND SERVER PLATFORM THEREOF

(71) Applicant: INSTITUTE FOR INFORMATION INDUSTRY, Taipei City (TW)

(72) Inventors: Yao-Min Huang, Taipei City (TW); Wen-Shan Liou, New Taipei City (TW)

(21) Appl. No.: 14/707,426

(22) Filed: May 8, 2015

(30) Foreign Application Priority Data
Feb. 23, 2015 (TW) 104105014

(51) Int. Cl. H04H 60/66; G10L 25/72; H04H 60/59; H04H 60/58; H04N 21/442; G10L 15/30; H04N 21/24

(52) U.S. Cl. CPC H04H 60/66; G10L 15/30; G10L 25/72; H04N 21/2407; H04H 60/58; H04N 21/44213; H04H 60/59

(57) ABSTRACT

A distributed multimedia recognition system comprises a user equipment and a server platform, wherein the user equipment is connected to the server platform. The user equipment transmits a recognition request, and performs characteristic extraction on a multimedia, so as to obtain characteristic data. The server platform receives the recognition request, selects one or multiple batches of corresponding reference characteristic data among multiple batches of reference characteristic data recorded in a characteristic database thereof according to a condition of the recognition request, and sends the one or multiple batches of the corresponding reference characteristic data to the user equipment. The user equipment compares the characteristic data to the one or multiple batches of the corresponding reference characteristic data to obtain a recognition result.

### BACKGROUND

1. Technical Field

The present disclosure relates to a multimedia recognition system; in particular, to a distributed multimedia recognition system, a method and a server platform thereof, in which the user equipment performs multimedia recognition.

2. Description of Related Art

In an interactive multimedia system, the user can operate her/his user equipment (such as smart phone, tablet, or other electronic device capable of connecting to the server platform which is set up by the program provider) to join the events or activities (such as program check-in for lottery drawing or real-time performer voting) held by the program provider, when she or he watches or listens to the multimedia (such as video, image, or audio) provided by the program provider. In order to ensure that the user is currently watching or listening to the multimedia, the interactive multimedia itself can be designed to contain a multimedia recognition system.

The conventional multimedia recognition system comprises a user equipment, a multimedia presentation device (such as liquid crystal display television, digital audio broadcasting receiver, or other electronic device capable of presenting the multimedia), and a recognition server. The user equipment establishes a connection to the recognition server via at least one communication link directly or through Internet. The multimedia presentation device is used to present the multimedia which the user watches or listens to. The recognition server has a characteristic database for storing multiple batches of reference characteristic data associated with different multimedia.

The user equipment can be operated by the user to acquire the characteristic data of the multimedia which the user current watches or listens to. Next, the user equipment transmits the characteristic data to the recognition server, and the recognition server compares the characteristic data to the multiple batches of the reference characteristic data recorded in the characteristic database, so as to recognize the multimedia which the user currently watches or listens to. Obviously, the conventional multimedia recognition system utilizes the recognition server to perform multimedia recognition, and the recognition server has a large number of computations, thus increasing operating cost of the program provider.

On the other hand, since that batch number of the multiple batches of reference characteristic data recorded in the characteristic database is very large, the multiple batches of reference characteristic data cannot be stored in the user equipment, and the user equipment thus cannot perform the multimedia recognition. Even if the user equipment is designed to have a large storage space for storing the multiple batches of reference characteristic data of the characteristic database, the computing ability of the user equipment is not enough to compare the characteristic data to the massive batches of the reference characteristic data, and that is, the user equipment merely can compare the characteristic data to the little batches of the reference characteristic data.

### SUMMARY

An exemplary embodiment of the present disclosure provides a distributed multimedia recognition system comprising a user equipment and a server platform, wherein the user equipment is connected to the server platform. The user equipment transmits a recognition request, and performs characteristic extraction on a multimedia, so as to obtain characteristic data. The server platform receives the recognition request, selects one or multiple batches of corresponding reference characteristic data among multiple batches of reference characteristic data recorded in a characteristic database thereof according to a condition of the recognition request, and sends the one or multiple batches of the corresponding reference characteristic data to the user equipment. The user equipment compares the characteristic data to the one or multiple batches of the corresponding reference characteristic data to obtain a recognition result.

On the other hand, exemplary embodiments of the present disclosure further provide a distributed multimedia recognition method and a server platform in the distributed multimedia recognition system.

To sum up, the distributed multimedia recognition system, method and the server platform thereof can decrease the number of computations of the server platform, and lower the operating cost of the program provider. By not transferring the characteristic data to the server for comparison, the distributed multimedia recognition system can also eliminate the time delay of network transfer, and thus speed up the recognition response at the user equipment.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a schematic diagram of a distributed multimedia recognition system according to an exemplary embodiment of the present disclosure.

FIG. 2A is a block diagram of a server platform in a distributed multimedia recognition system according to an exemplary embodiment of the present disclosure.

FIG. 2B is a block diagram of a user equipment in a distributed multimedia recognition system according to an exemplary embodiment of the present disclosure.

FIG. 3 is a flow chart of a distributed multimedia recognition method executed in the server platform according to an exemplary embodiment of the present disclosure.

FIG. 4A is a flow chart of a distributed multimedia recognition method executed in the distributed multimedia recognition system according to an exemplary embodiment of the present disclosure.

FIG. 4B is a flow chart of a distributed multimedia recognition method executed in the distributed multimedia recognition system according to another exemplary embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

An exemplary embodiment of the present disclosure provides a distributed multimedia recognition system, and the distributed multimedia recognition system comprises a user equipment and a server platform, wherein the server platform is connected to the user equipment. The server platform can select one or multiple batches of corresponding reference characteristic data according to a condition transmitted from the user equipment. After the server platform selects the multiple batches of the corresponding reference characteristic data, the server platform can further sort the multiple batches of the corresponding reference characteristic data according to the statistics information, and sends the one or sorted multiple batches of the corresponding reference characteristic data to the user equipment. Thus, the user equipment compares the extracted characteristic data merely to the one or sorted multiple batches of the corresponding reference characteristic data. When the user equipment finds a correlation of the extracted characteristic data and one of the sorted multiple batches of the corresponding reference characteristic data is larger than a threshold value, the comparing operation is stopped, such that the multimedia recognition is ended early, the speed of the multimedia recognition is increased, and the computation number of the user equipment is lowered.

In short, the distributed multimedia recognition system does not perform the comparing operation of the multimedia recognition by using the server platform, and instead, the distributed multimedia recognition system utilizes the condition and statistics information to make the server platform to select and sort from the multiple batches of the corresponding reference characteristic data to create a small subset, and send to the user equipment. Then, the user equipment compares the characteristic data to the small subset batches of the corresponding reference characteristic data, so as to carry out the multimedia recognition. Accordingly, the number of computations of the server platform is decreased, and the operating cost of the program provider is lowered.

Furthermore, deduced from the distributed multimedia recognition system according the exemplary embodiment of the present disclosure, exemplary embodiments of the present disclosure provide a distributed multimedia recognition method and a server platform. Main steps of the distributed multimedia recognition method are executed in the server platform, such that the server platform can provide the sorted multiple batches of the corresponding reference characteristic data to the user equipment, and the user equipment can perform the comparing operation of the multimedia recognition. Details of a distributed multimedia recognition system, a method and a server platform thereof according to exemplary embodiments of the present disclosure are illustrated as follows, and the implementations of the exemplary embodiments are not used to limit the present disclosure.

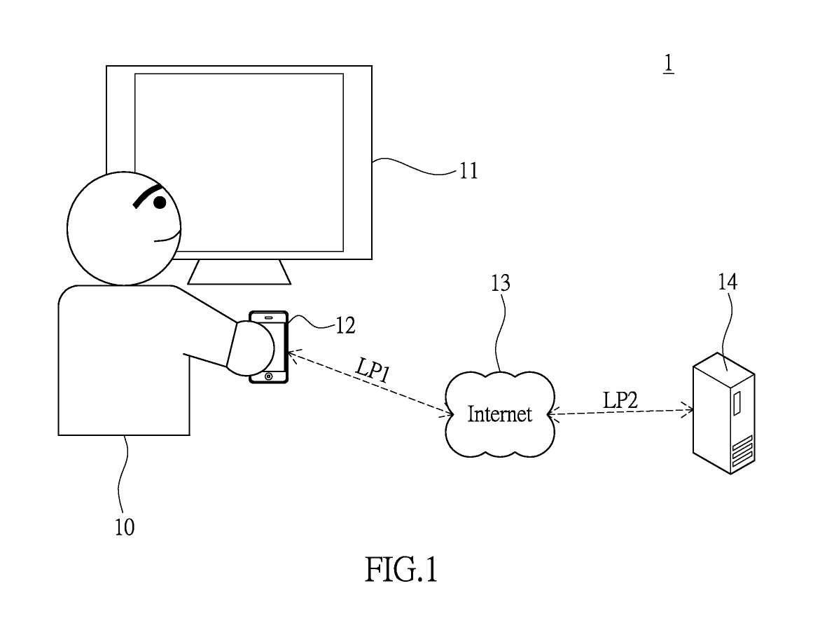

Referring to FIG. 1, FIG. 1 is a schematic diagram of a distributed multimedia recognition system according to an exemplary embodiment of the present disclosure. The distributed multimedia recognition system 1 comprises a multimedia presentation device 11, a user equipment 12, Internet 13, and a server platform 14. In the exemplary embodiment, there is a communication link LP1 between the user equipment 12 and Internet 13, and there is a communication link LP2 between the server platform 14 and Internet 13, such that the user equipment 12 is connected to the server platform 14 via the communication links LP1, LP2.

The multimedia presentation device 11 can be a television, digital audio broadcasting receiver, or other electronic device capable of presenting the multimedia. The multimedia presentation device 11 can receive multimedia of different types, such as video, image, or audio, and the type of multimedia presentation device 11 is not used to limit the present disclosure. The program provider can wirelessly or wiredly transmit or broadcast the multimedia to the multimedia presentation device 11, such that the user 10 can watch or listen to the multimedia produced by the program provider.

The user equipment 12 can be a smart phone, tablet, or other electronic device with a communication function, a specific application program is installed therein, and the type of the user equipment 12 is not used to limit the present disclosure. When the user 10 is interested in a segment of video, audio, or one image in the multimedia presented by the multimedia presentation device 11, or wants to join the activities or events indicated by the auxiliary message related to the multimedia (such as the scrolling text presented by the multimedia presentation device 11 or the notifying message alarmed by the specific application program of the user equipment 12), the user 10 can use the specific application program installed in the user equipment 12 to acquire the segment of video, audio, or one image in the multimedia currently or next presented by multimedia presentation device 11, such as by the sensor thereof or via the local network.

After the user equipment 12 acquires a segment of video, audio, or one image in the multimedia currently or next presented by the multimedia presentation device 11, the user equipment 12 performs characteristic analysis on the segment of video, audio, or one image, and accordingly extracts the corresponding characteristic data. Corresponding to the type of the multimedia, the characteristic data can be audio fingerprint, object characteristic, image chain code, or characteristic frequency, and the type of the characteristic data is not used to limit the present disclosure.

The user equipment 12 does not transmit the characteristic data to the server platform 14, and by contrast, the specific application program of user equipment 12 orders the user equipment 12 to transmit the recognition request comprising the condition and the user identification to the server platform 14, so as to request the server platform 14 to return one or multiple batches of corresponding reference data matching to the condition, wherein the user equipment 12 can transmit the recognition request before or after the multimedia is acquired, and the present disclosure is not limited thereto.

After the server platform 14 receives the recognition request, the server platform 14 selects one or multiple batches of the corresponding reference characteristic data among multiple batches of reference characteristic data recorded in a characteristic database thereof according to the condition of the recognition request. If the multiple batches of the corresponding reference characteristic data are selected, the server platform 14 further sorts the multiple batches of the corresponding reference characteristic data according to statistics information, and sends the sorted multiple batches of the corresponding reference characteristic data to the user equipment 12 corresponding to the user identification.

Next, the user equipment 12 compares the characteristic data to the received one or multiple batches of the corresponding reference characteristic data, so as to find a reference characteristic data which has the maximum correlation or the correlation larger than the threshold value, and the multimedia corresponding to the found reference characteristic data is possibly the multimedia currently been watched or listened to by the user 10. Preferred, after the user equipment 12 finds the reference characteristic data which has the correlation larger than the threshold value, the comparing operation is stopped. The user equipment 12 can execute a corresponding application according to the recognition result (such as program check-in for lottery drawing or real-time performer noting), and the recognition result can be transmitted to the server platform 14, such that the server platform 14 can update the statistics information according to the recognition result.

It is noted that, the condition can be a region of the user 10, a displaying time, a displaying channel, a mark, a program type, an actress/actor name, an activity code, and the type of the condition is not used to limit the present disclosure. In the exemplary embodiment, the condition can be pre-defined by the developer of the specific application program, and the condition can be updated periodically or automatically, such that the condition can correspond to the new events or activities published by the program provider. Thus, when the user 10 activates the specific application program installed in the user equipment 12, the user 10 merely performs simple operation (such as a gesture or virtual button touch) to indicate the user equipment 12 to start to acquire the multimedia and to automatically transmit the recognition request to the server platform 14.

The statistics information can be a rule for sorting the multiple batches of the corresponding reference characteristic data. At least one portion of the statistics information can relate to the user identification, and the statistics database of server platform 14 collects multiple batches of the recognition results corresponding to the user identification to analyze the behavior and preference of the user 10 or the user group corresponding to the user identification. The other portion of the statistics information does not relate to the user identification, and comprises a whole audience rate and a comment rate. In one other exemplary embodiment, all portion of the statistics information does not relate to the user identification, and the recognition request correspondingly does not comprise the user identification.

It is noted that, in the exemplary embodiment, the multimedia presentation device 11 can be removed, and the user equipment 12 can present the multimedia to the user. Or alternatively, the user equipment 12 itself can be integrated into the multimedia presentation device 11, such that the multimedia presentation device 11 a smart multimedia presentation device, such as a smart television. In addition, Internet 13 can be also removed, and the user equipment 12 can be connected to the server platform 14 via merely one communication link.

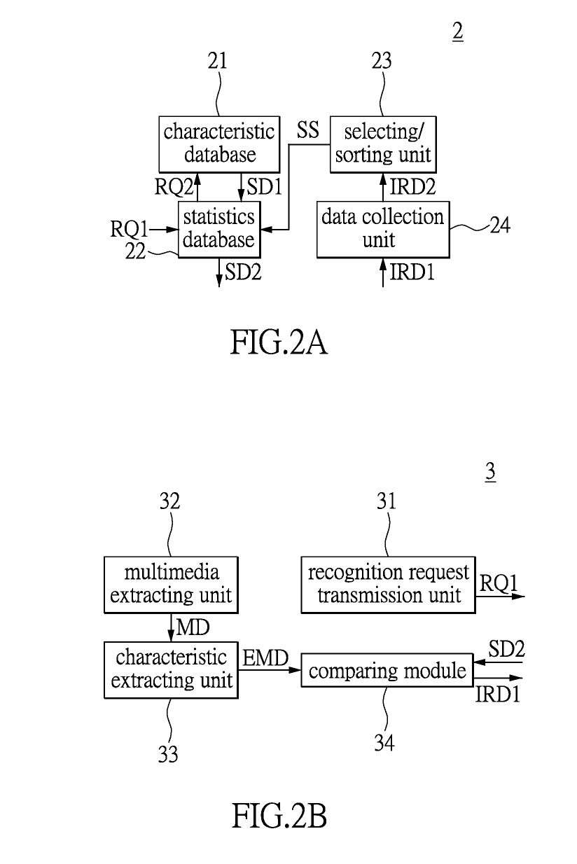

Next, implementation details of the server platform in the distributed multimedia recognition system are illustrated as follows, and the implementations of the server platform are not used to limit the present disclosure. Referring to FIG. 2A, FIG. 2A is a block diagram of a server platform in a distributed multimedia recognition system according to an exemplary embodiment of the present disclosure. The server platform 2 in FIG. 2A is implemented by one or multiple circuits (even accompanying with firmware or software), and comprises a characteristic database 21, a selecting/sorting unit 22, a statistics database 23, and a data collection unit 24, wherein the characteristic database 21 is electrically coupled to the selecting/sorting unit 22, the selecting/sorting unit 22 is electrically coupled to the statistics database 23, and the statistics database 23 is electrically coupled to the data collection unit 24.

In the exemplary embodiment, the characteristic database 21 records multiple batches of the multiple batches of reference characteristic data of all different multimedia. The selecting/sorting unit 22 receives the recognition request RQ1 from the user equipment, wherein the recognition request RQ1 comprises the condition and the user identification. The selecting/sorting unit 22 can generate the recognition request RQ2 comprising the condition according to the recognition request RQ1, and send the recognition request RQ2 to the characteristic database 21, so as to query characteristic database 21 to return one or multiple batches of the reference characteristic data SD1 matching the condition. The format of the recognition request RQ1 may not be readable for the characteristic database 21, thus the selecting/sorting unit 22 can further transform format of the recognition request RQ1 to generate the recognition request RQ2 which is readable for the characteristic database 21. In other exemplary embodiment, the recognition request RQ1 may be identical to the recognition request RQ2.

The statistics database 23 records the statistics information, and at least portion of the statistics information relates to the user identification, or all the statistics information does not relate to the user identification. In the exemplary embodiment, take at least portion of the statistics information relates to the user identification as an example for illustrating. The statistics database 23 sends the statistics information SS to the selecting/sorting unit 22, and the selecting/sorting unit 22 can sort the selected multiple batches of reference characteristic data SD1 according to the statistics information SS, to generate the multiple batches of reference characteristic data SD2 to the user equipment. In one other exemplary embodiment, if merely one batch of the reference characteristic data SD1 is selected, the reference characteristic data SD1 is identical to the reference characteristic data SD2, and the selecting/sorting unit 22 does not sort reference characteristic data SD1.

The user equipment compares the characteristic data to the one or multiple batches of the reference characteristic data SD2, and generate the recognition result IRD1. The recognition result IRD1 is received by the data collection unit 24, and the data collection unit 24 generates the recognition result IRD2 to the statistics database23 according to the recognition result IRD1, such that the statistics database 23 can update the statistics information SS according to the recognition result IRD2. The recognition result IRD1 comprises information of matched multimedia and the user identification. The format recognition result IRD1 may be not readable for the statistics database 23, and thus the data collection unit 24 can further transform the format of the recognition result IRD1 to generate the recognition result IRD2 which is readable for the statistics database 23. In one other exemplary embodiment, the recognition result IRD1 can be identical to the recognition result IRD2.

Next, implementation details of the user equipment in the distributed multimedia recognition system are illustrated as follows, and the implementations of the user equipment are not used to limit the present disclosure. Referring to FIG. 2B, FIG. 2B is a block diagram of a user equipment in a distributed multimedia recognition system according to an exemplary embodiment of the present disclosure. The user equipment 3 in FIG. 2B is implemented by one or multiple circuits (even accompanying with firmware or software), and comprises a recognition request transmission unit 31, a multimedia extracting unit 32, a characteristic extracting unit 33, and a comparing module 34, wherein the multimedia extracting unit 32 is electrically coupled to the characteristic extracting unit 33, and the characteristic extracting unit 33 is electrically coupled to the comparing module 34.

The recognition request transmission unit 31 can transmit the recognition request RQ1 to the server platform, after or before the multimedia extracting unit 32 acquire one segment of the multimedia MD to extract the characteristic data EMD. The characteristic extracting unit 33 is used to extract the characteristic data EMD of the multimedia MD, and transmit the characteristic data EMD to the comparing module 34. The comparing module 34 receives the one or multiple batches of the reference characteristic data SD2 from the server platform, and compares the characteristic data EMD to the one or multiple batches of the reference characteristic data SD2, so as to generate the recognition result IRD1.

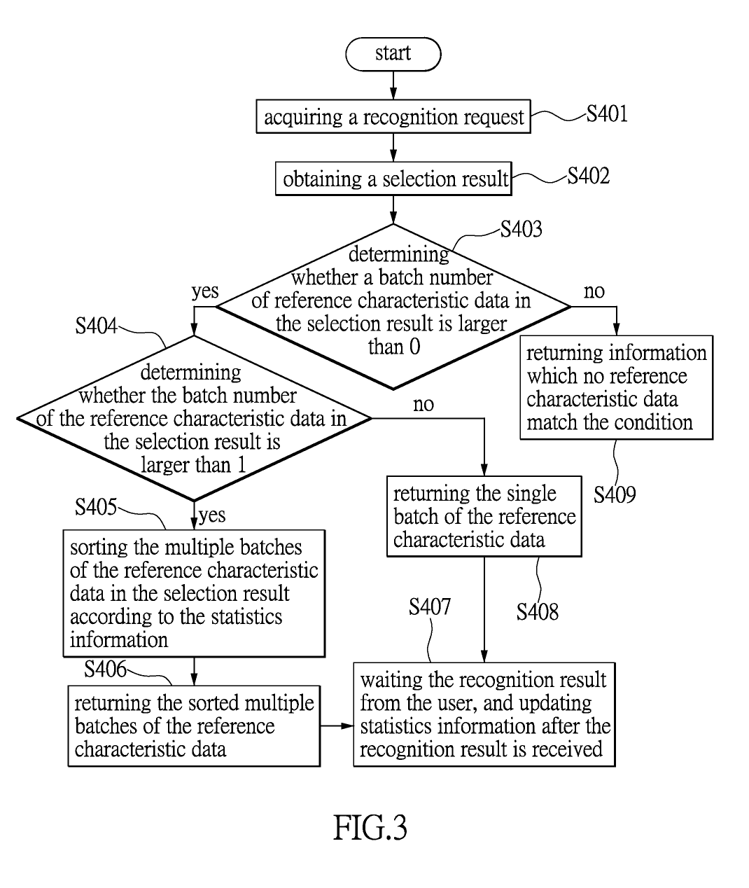

Next, details of the distributed multimedia recognition method of the exemplary embodiment of the present disclosure are illustrated. Referring to FIG. 3, FIG. 3 is a flow chart of a distributed multimedia recognition method executed in the server platform according to an exemplary embodiment of the present disclosure. The distributed multimedia recognition method can comprise steps of FIG. 3, but present disclosure is not limited thereto. Firstly, at step S401, the server platform obtains the recognition request of the user equipment. Next, at step S402, the server platform selects one or multiple batches of the corresponding reference characteristic data among the reference characteristic data recorded in the characteristic database thereof according to the condition, so as to generate a selection result.

Next, at step S403, the server platform determines whether the batch number of the reference characteristic data in the selection result is larger than 0. If the batch number of the reference characteristic data in the selection result is not larger than 0, it means no reference characteristic data matching to the condition are found, and at step S409, the server platform returns information which no reference characteristic data match the condition to the user equipment. If the batch number of the reference characteristic data in the selection result is larger than 0, the server platform then determines whether the batch number of the reference characteristic data in the selection result is larger than 1 at step S404.

If the batch number of the reference characteristic data in the selection result is 1, it mean merely one batch of the reference characteristic data matches the condition, and at step S408, the server platform transmits the one batch of the reference characteristic data to the user equipment. If the batch number of the reference characteristic data in the selection result is larger than 1, the server platform sorts the multiple batches of the reference characteristic data in the selection result according to the statistics information at step S405, and next returns the sorted multiple batches of reference characteristic data to the user equipment at step S406. Next, at step S407, the server platform waits the recognition result returned from the user equipment, and updates the statistics information according to the recognition result after receiving the recognition result from the user equipment.

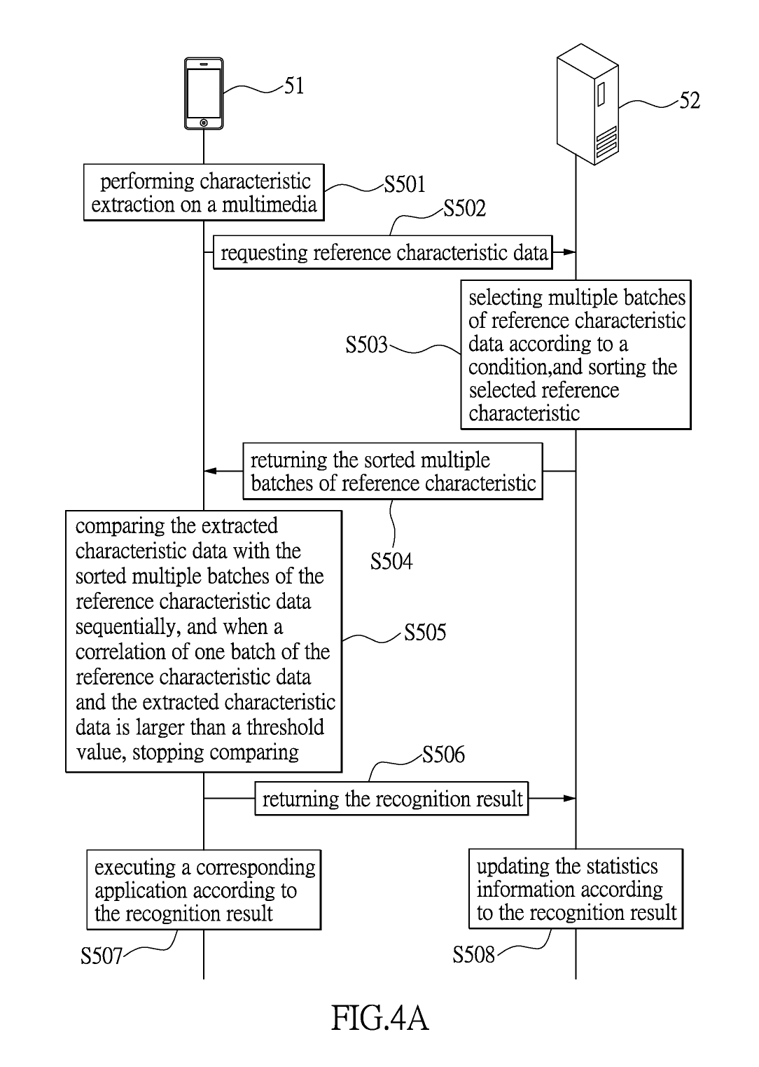

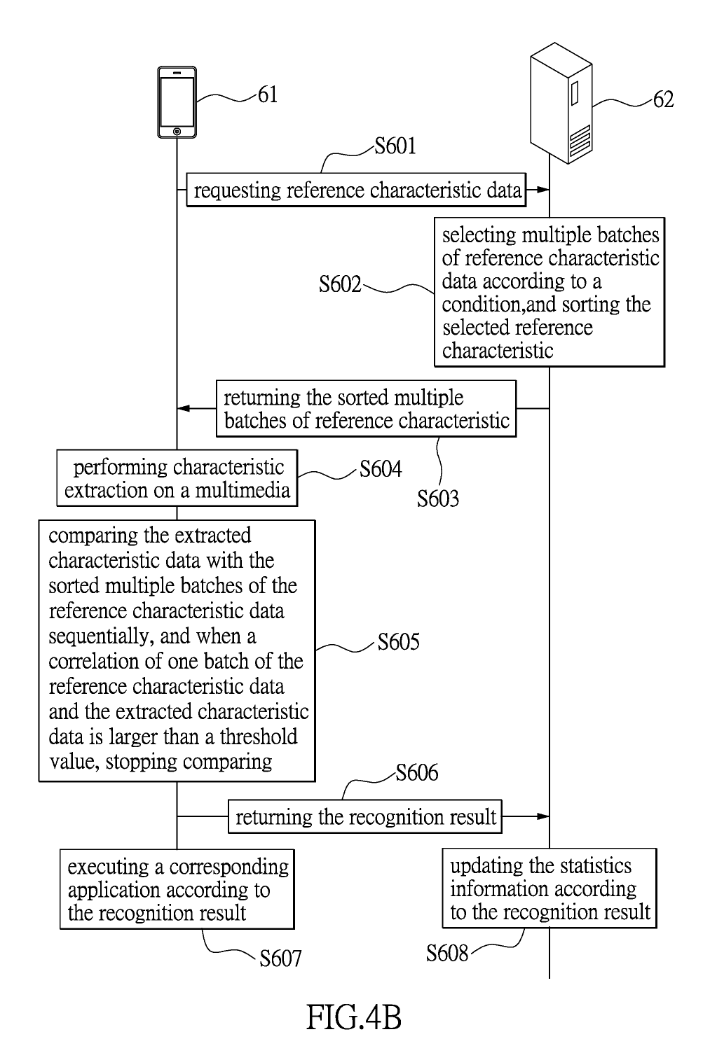

The distributed multimedia recognition method according to the exemplary embodiment not only comprises the steps executed in the server platform, but also the steps executed in the user equipment. Referring to FIG. 4A, FIG. 4A is a flow chart of a distributed multimedia recognition method executed in the distributed multimedia recognition system according to an exemplary embodiment of the present disclosure. Firstly, at step S501, the user equipment 51 performs characteristic extraction on a multimedia, and then at step S502, transmits the recognition request to the server platform 52 for querying one or multiple batches of reference characteristic data matching the condition of the recognition request. Next, at step S503, the server platform 52 selects multiple batches of the reference characteristic data matching to the condition, and sort the selected multiple batches of reference characteristic data according to the statistics information. Then, at step S504, the server platform 52 returns the sorted multiple batches of reference characteristic data to the user equipment 51.

At step S505, the user equipment 51 compares the extracted characteristic data with the sorted multiple batches of the reference characteristic data sequentially, and when a correlation of one batch of the reference characteristic data and the extracted characteristic data is larger than a threshold value, the user equipment 51 stops comparing, so as to save computations of the user equipment and increase the comparing speed. Next, at step S506, the user equipment 51 returns the recognition result to the server platform 52. At step S507, the user equipment 51 executes a corresponding application according to the recognition result, and at step S508, the server platform 52 updates the statistics information according to the recognition result. In addition, the execution order of steps S506 and S507 is not used to limit the present disclosure, and the execution time of step S501 is also not used to limit the present disclosure.

Next, referring to FIG. 4B, FIG. 4B is a flow chart of a distributed multimedia recognition method executed in the distributed multimedia recognition system according to another exemplary embodiment of the present disclosure. In the exemplary embodiment, steps S601 through S603 are respectively the same as steps S502 through S504 in FIG. 4A, step S604 is the same as step S501 in FIG. 4A, and steps S605 through S608 are respectively the same as steps S505 through S508 in FIG. 4A. The difference between the exemplary embodiments of FIG. 4A and FIG. 4B is that step S604 is executed after step S603. That is, in the exemplary embodiment of FIG. 4A, the user equipment 51 performs the characteristic extraction on the multimedia before the user equipment 51 request the server platform 52 to return the corresponding reference characteristic data, and this exemplary embodiment is the application of the real-time multimedia recognition; by contrast, in the exemplary embodiment of FIG. 4B, the user equipment 61 performs the characteristic extraction on the multimedia after the user equipment 61 request the server platform 62 to return the corresponding reference characteristic data, and this exemplary embodiment is the application for recording the next presented multimedia and the application of next presented multimedia recognition.

It is noted that, the present disclosure does not limit the distributed multimedia recognition system to be applied in field of the interactive multimedia, and the distributed multimedia recognition system can even applied in the field of medical image recognition. The specific application programs installed in the user equipments used by the nursing aides of different divisions have different conditions, and the usually used medical images of different divisions are different from each other.

For example, before the doctor of the urology division performs the surgical operation, the nursing aide of the urology division should photograph the surgical part to check whether the surgical part is correct. The usual surgical operations of the urology division may be circumcise, varicocele, and hernia in order, and the medical images of the surgical parts are different from each other. Before the surgical operation is performed, the nursing aide can use the user equipment to photograph the surgical part, and request the one or sorted multiple batches of the reference characteristic data from the server platform to recognize the surgical part, so as to ensure the surgical part is correct. The condition can be used to describe the surgical part, and pre-recorded in the identification hand ring of the patient via the barcode. Before the nursing aide photographs the surgical parts, the nursing aide can uses the user equipment to read the barcode, and the condition is then send to the specific application program installed in the user equipment, thus increasing the recognition accuracy and decreasing the possibility that the doctor performs surgical operation on the wrong surgical part.

To sum up, the distributed multimedia recognition system, method, and server platform thereof provided by the exemplary embodiments of the present disclosure can make the user equipment compare the extracted characteristic data and the single one or multiple batches of reference characteristic data, so as to carry out multimedia recognition. Thus, a large number of computations can be decreased, and the operating cost of program provider can be lowered.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A distributed multimedia recognition system, comprising:
a user equipment, used to transmit a recognition request, and perform characteristic extraction on a multimedia, so as to obtain characteristic data; and
a server platform, connected to the user equipment, having a characteristic database, used to receive the recognition request, select one or multiple batches of corresponding reference characteristic data among multiple batches of reference characteristic data recorded in a characteristic database thereof according to a condition of the recognition request, and send the one or multiple batches of the corresponding reference characteristic data to the user equipment;
wherein the user equipment compares the characteristic data to the one or multiple batches of the corresponding reference characteristic data to obtain a recognition result.

2. The distributed multimedia recognition system according to claim 1, wherein the server platform further comprises a statistics database, the server platform sorts the multiple batches of the corresponding reference characteristic data according to statistics information, and sends the sorted multiple batches of the corresponding reference characteristic data to the user equipment.

3. The distributed multimedia recognition system according to claim 2, wherein the recognition request further comprises a user identification corresponding to the user equipment, and at least portion of the statistics information corresponds to the user identification.

4. The distributed multimedia recognition system according to claim 1, wherein before the user equipment transmits the recognition request, the user equipment performs the characteristic extraction on the multimedia; or after the user equipment transmits the recognition request, the user equipment performs the characteristic extraction on the multimedia.

5. The distributed multimedia recognition system according to claim 2, wherein the user equipment executes a corresponding application according to the recognition result, and returns the recognition result to the server platform, and the server platform updates the statistics information according to the recognition result.

6. The distributed multimedia recognition system according to claim 1, wherein the condition comprises at least one of a region, a displaying time, a displaying channel, a mark, a program type, an actress/actor name, an activity code.

7. The distributed multimedia recognition system according to claim 3, wherein the statistics information comprises at least one of a behavior and a preference associated with a user or a user group corresponding to the user identification, a whole audience rate, and a comment rate.

8. The distributed multimedia recognition system according to claim 1, wherein the multimedia is a video, an image, or an audio.

9. A distributed multimedia recognition method, comprising:
in a server platform connected to a user equipment:
receiving a recognition request from the user equipment;
selecting one or multiple batches of corresponding reference characteristic data among multiple batches of reference characteristic data recorded in a characteristic database thereof according to a condition of the recognition request; and
sorting the multiple batches of the corresponding reference characteristic data according to statistics information recorded in a statistics database thereof, and sending the one or sorted multiple batches of the corresponding reference characteristic data to the user equipment.

10. The distributed multimedia recognition method according to claim 9, further comprising:
in the user equipment:
transmitting the recognition request;
performing characteristic extraction on a multimedia to obtain characteristic data;
comparing the characteristic data to the one or sorted multiple batches of the corresponding reference characteristic data to obtain a recognition result;
executing a corresponding application according to the recognition result; and
returning the recognition result to the server platform.

11. The distributed multimedia recognition method according to claim 9, wherein the recognition request further comprises a user identification corresponding to the user equipment, and at least portion of the statistics information corresponds to the user identification.

12. The distributed multimedia recognition method according to claim 10, wherein before the user equipment transmits the recognition request, the user equipment performs the characteristic extraction on the multimedia; or after the user equipment transmits the recognition request, the user equipment performs the characteristic extraction on the multimedia.

13. The distributed multimedia recognition method according to claim 10, further comprising:
in the server platform:
updating the statistics information according to the recognition result.

14. The distributed multimedia recognition method according to claim 11, wherein the condition comprises at least one of a region, a displaying time, a displaying channel, a mark, a program type, an actress/actor name, an activity code; the statistics information comprises at least one of a behavior and a preference associated with a user or a user group corresponding to the user identification, a whole audience rate, and a comment rate; and the multimedia is a video, an image, or an audio.

15. A server platform, used in a distributed multimedia recognition system, connected to a user equipment of the distributed multimedia recognition system, comprising:
one or multiple circuits, configured for:
receiving a recognition request from the user equipment;
selecting one or multiple batches of corresponding reference characteristic data among multiple batches of reference characteristic data recorded in a characteristic database thereof according to a condition of the recognition request;
sorting the multiple batches of the corresponding reference characteristic data according to statistics information recorded in a statistics database thereof, and sending the one or sorted multiple batches of the corresponding reference characteristic data to the user equipment; and
updating the statistics information according to a recognition result from the user equipment.

16. The server platform according to claim 15, wherein the recognition request further comprises a user identification corresponding to the user equipment, and at least portion of the statistics information corresponds to the user identification.

17. The server platform according to claim 15, wherein the condition comprises at least one of a region, a displaying time, a displaying channel, a mark, a program type, an actress/actor name, an activity code.

18. The server platform according to claim 16, wherein the statistics information comprises at least one of a behavior and a preference associated with a user or a user group corresponding to the user identification, a whole audience rate, and a comment rate.

19. The server platform according to claim 15, wherein the multimedia is a video, an image, or an audio.
